(19) United States
(12) Patent Application Publication
(10) Pub. No.: US 2011/0072619 A1
(43) Pub. Date: Mar. 31, 2011

(54) HINGE

(75) Inventors: Hung-Chi Wang, Taipei (TW); Chin-Te Chiu, Taipei (TW); Mei-Chuan Yang, Taipei (TW)

(73) Assignee: CHENG UEI PRECISION INDUSTRY CO., LTD., Taipei (TW)

(21) Appl. No.: 12/568,249

(22) Filed: Sep. 28, 2009

(51) Int. Cl. E05D 11/08

(52) U.S. Cl. 16/339; 16/342

(57) ABSTRACT

A hinge includes a second connector having a hollow pivotal device of which a peripheral outside protrudes outward to form a locking rib, and a first connector having a pivotal sleeve which is pivotally sleeved to the pivotal device to make the first connector rotatable relative to the second connector. The locking rib is able to slide along and abut against a peripheral inside of the pivotal sleeve to produce friction resistance force therebetween for positioning the first connector at any inclined angle relative to the second connector. A fastening pin is disposed in the pivotal device of the second connector and spaced from a peripheral inside of the pivotal device so that can make the pivotal device pressed inward to produce an outward elasticity to strengthen the friction resistance force between the locking rib and the peripheral inside of the pivotal sleeve.

### BACKGROUND OF THE INVENTION

1. Field of the Invention

The present invention generally relates to a hinge, and more particularly to a hinge adapted for a foldable electronic appliance such as a notebook computer, a flip phone, and the like.

2. The Related Art

Conventionally, a foldable electronic appliance, such as a notebook computer, a flip phone and so on, has a host body and a display apparatus pivoted to the host body by means of a hinge. The display apparatus can be unfolded when in use, and be folded to couple on the host body when not in use so as to reduce the size to facilitate storing and carrying.

Referring to FIG. 6, a traditional hinge includes a second connector 20′ having a pintle 21′, a first connector 10′ pivoted to the pintle 21′ by means of a pivotal flange 11′ thereof, a plurality of positioning detents 30′ and a plurality of resilient spacers 40′ alternately wore to the pintle 21′. Finally a free end of the pintle 21′ is engaged with a nut 50′ to preclude disengagement of the pivotal flange 11′, the positioning detents 30′ and the resilient spacers 40′ from the pintle 21′. The first connector 10′ further has a latch finger 12′ near to the pintle 21′. One of the positioning detents 30′ is acted as a braking element 31′ buckled with the latch finger 12′. The second connector 20′ is secured to the host body and the first connector 10′ is secured to the display apparatus so that the display apparatus may be swiveled about the pintle 21′ for folding and unfolding relative to the host body. In the process of opening the display apparatus relative to the host body, the first connector 10′ is driven to swivel about the pintle 21′ that further drives the pivotal flange 11′ and the braking element 31′ to swivel relative to other positioning detents 30′ and the resilient spacers 40′ for generating friction resistance force thereamong. So the display apparatus is positioned relative to the host body by means of the friction resistance force.

However, the traditional hinge has too many components and a complicated assembly, and takes a high cost. So it would be desirable to provide an improved hinge capable of overcoming the foregoing problems.

### SUMMARY OF THE INVENTION

An object of the present invention is to provide a hinge adapted to be connected between a display apparatus and a host body of a foldable electronic appliance for permitting the display apparatus to be swiveled relative to the host body. The hinge includes a first connector, a second connector and a fastening pin. The second connector has a hollow pivotal device and a second fastening member adapted to be fastened to the host body of the electronic appliance. A peripheral outside of the pivotal device protrudes outward to form a locking rib. The first connector has a pivotal sleeve and a first fastening member adapted to be fastened to the display apparatus of the electronic appliance. The pivotal sleeve is pivotally sleeved to the pivotal device to make the first connector rotatable relative to the second connector and further make the display apparatus swivelable relative to the host body. The locking rib of the pivotal device is able to slide along and abut against a peripheral inside of the pivotal sleeve to produce friction resistance force therebetween for positioning the display apparatus at any inclined angle relative to the host body. The fastening pin is disposed in the pivotal device of the second connector and spaced from a peripheral inside of the pivotal device so that can make the pivotal device pressed inward to produce an outward elasticity to strengthen the friction resistance force between the locking rib and the peripheral inside of the pivotal sleeve.

As described above, the hinge of the present invention only includes the first connector, the second connector and the fasting pin, and utilizes the friction resistance force between the locking rib of the second connector and the peripheral inside of the pivotal sleeve of the first connector to make the display apparatus positioned at any inclined angle relative to the host body. So the hinge of the present invention has simple structure and assembly, and further reduces the manufacture cost.

### BRIEF DESCRIPTION OF THE DRAWINGS

The present invention will be apparent to those skilled in the art by reading the following description, with reference to the attached drawings, in which:

FIG. 1 is a perspective view of a hinge in accordance with the present invention;

FIG. 2 is an exploded perspective view of the hinge of FIG. 1;

FIG. 3 is a lateral view of a first connector of the hinge of FIG. 1;

FIG. 4 is a lateral view of a second connector of the hinge of FIG. 1;

FIG. 5 is a perspective view showing that the hinge of FIG. 1 is used in a notebook computer, wherein a display apparatus of the notebook computer is partially cut away to expose the hinge; and

FIG. 6 is a perspective view of a hinge according to the prior art.

### DETAILED DESCRIPTION OF THE PREFERRED EMBODIMENT

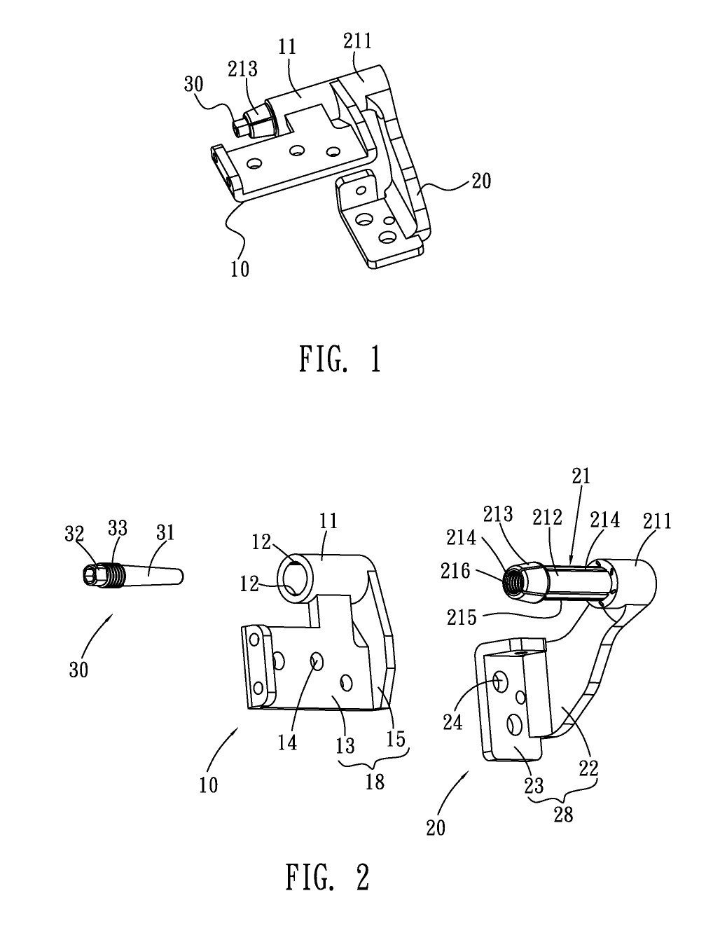

With reference to FIG. 1 and FIG. 2, a hinge in accordance with the present invention includes a first connector 10, a second connector 20 and a fastening pin 30.

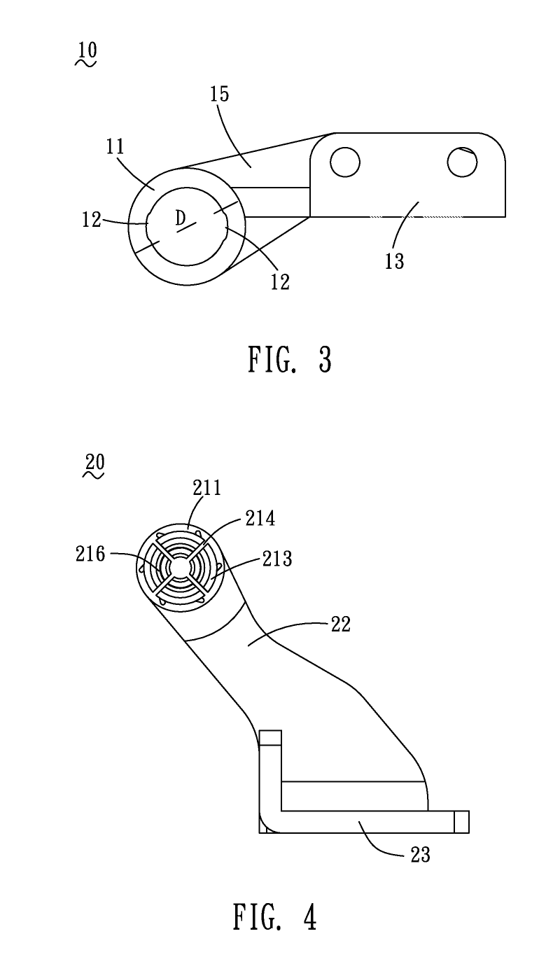

Referring to FIG. 2 and FIG. 3, the first connector 10 includes a cylindrical pivotal sleeve 11, and a first fastening member 18 connected with the pivotal sleeve 11. The first fastening member 18 includes a substantially board-shaped coupling flap 13 connected with a peripheral outside of the pivotal sleeve 11 along a generatrix of the pivotal sleeve 11 for always showing an oblique angle between the coupling flap 13 and a corresponding diameter D, wherein the corresponding diameter D is the one passing through the junction of the coupling flap 13 and the pivotal sleeve 11. An inside of the pivotal sleeve 11 defines a pair of buckling grooves 12 which are parallel with and further symmetrical about the axis of the pivotal sleeve 11. The coupling flap 13 defines a plurality of fastening holes 14 each penetrating therethrough. The first fastening member 18 further includes a connection plate 15 connecting one end of the coupling flap 13 with the pivotal sleeve 11 at an oblique angle between the connection direction of the connection plate 15 and the plane of the coupling flap 13, wherein the plane of the connection plate 15 is perpendicular to the coupling flap 13 and the pivotal sleeve 11.

Referring to FIG. 2 and FIG. 4, the second connector 20 includes a pivotal device 21 and a second fastening member 28 connected with the pivotal device 21. The second fastening member 28 includes a substantially board-shaped fastening dock 23 and a connection board 22 connecting one end of the pivotal device 21 and an edge of the fastening dock 23. The plane of the fastening dock 23 is perpendicular to that of the connection board 22 and parallel to the pivotal device 21, and further shows an oblique angle about the extension direction of the connection board 22. The fastening dock 23 defines a plurality of fastening apertures 24 each penetrating therethrough. The pivotal device 21 is connected at the same side of the connection board 22 as the fastening dock 23, and includes a prop pillar 211 connected with the connection board 22 and a cylindrical hollow pintle 212 extending from a middle of an end surface of the prop pillar 211. A peripheral outside of a free end of the pintle 212 protrudes outward to form a cone-shaped restraining portion 213 having one end with the shortest diameter adjacent to the free end mouth of the pintle 212. The pintle 212 defines a plurality of slots 214 which are parallel with and symmetrical about the axis of the pintle 212. Each of the slots 214 further radially penetrates through the pintle 212 and the restraining portion 213. A pair of locking ribs 215 are oppositely protruded from a peripheral outside of the pintle 212 and extended parallelly to the slots 214. An inner side of the free end of the pintle 212 is provided with a female thread 216.

Referring to FIG. 2 again, the fastening pin 30 includes an inserting bar 31 and a handle portion 32 connected with one end of the inserting bar 31. The diameter of the inserting bar 31 is gradually reduced from the one end of the inserting bar 31 to the other end of the inserting bar 31. A peripheral outside of the one end of the inserting bar 31 is provided with a male thread 33 adjacent to the handle portion 32 and corresponding to the female thread 216 of the pivotal device 21.

Referring to FIG. 1 and FIG. 2 again, in assembly, the pivotal sleeve 11 of the first connector 10 is pivotally sleeved to the pintle 212 through the restraining portion 213, and is restrained between the prop pillar 211 and the restraining portion 213. Then the inserting bar 31 of the fastening pin 30 is inserted into the pintle 212, and the male thread 33 is screwed with the female thread 216 by means of turning around the handle portion 32. The inserting bar 31 is further spaced from the inside of the pintle 212, so the pintle 212 may produce an elastic deformation under an external pressure.

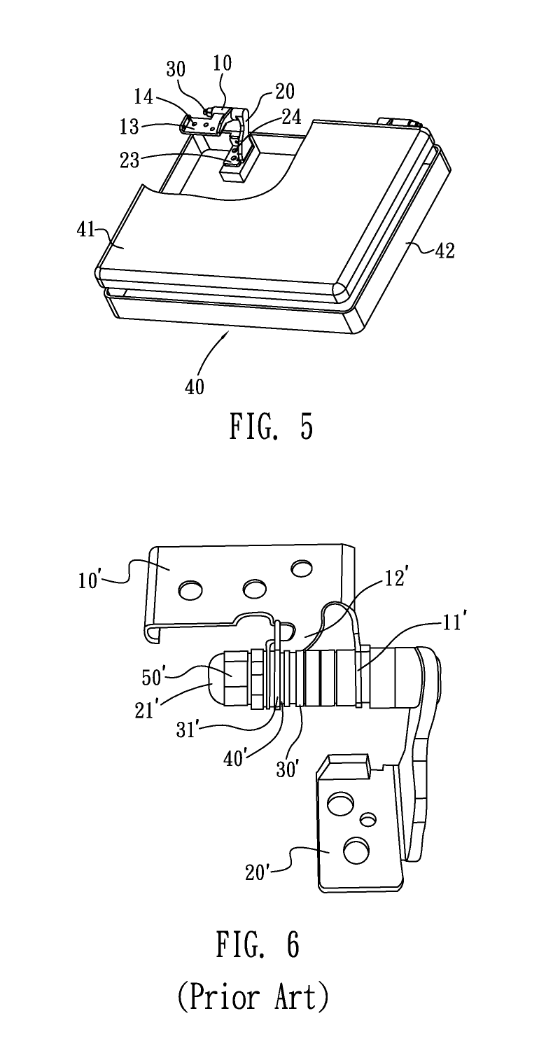

Referring to FIG. 5, it shows that the hinge of the present invention is used in a notebook computer 40 as an example. The notebook computer 40 includes a host body 42 and a display apparatus 41 pivoted to the host body 42 by means of the hinge, wherein the coupling flap 13 of the first connector 10 is secured to the display apparatus 41 by means of the fastening holes 14, and the fastening dock 23 of the second connector 20 is secured to the host body 42 by means of the fastening apertures 24. The display apparatus 41 may be swiveled about the pintle 212 of the hinge for folding and unfolding relative to the host body 42.

When the display apparatus 41 is folded and closed onto the host body 42, the locking ribs 215 of the second connector 20 are locked into the corresponding buckling grooves 12 of the first connector 10. In the process of opening the display apparatus 41 relative to the host body 42, the pivotal sleeve 11 is driven to rotate about the pintle 212 that makes the locking ribs 215 slide out of the corresponding buckling grooves 12 to abut against the inside of the pivotal sleeve 11. As a result, the pintle 212 is pressed inward to produce the elastic deformation that makes the locking ribs 215 tightly against the inside of the pivotal sleeve 11 for strengthening the friction resistance force between the locking ribs 215 and the inside of the pivotal sleeve 11. So the display apparatus 41 may be positioned at any inclined angle relative to the host body 42 by means of the friction resistance force. Furthermore, the friction resistance force between the locking ribs 215 and the inside of the pivotal sleeve 11 can be further strengthened by means of turning around the handle portion 32 to make the fastening pin 30 further go deep into the pintle 212.

As described above, the hinge of the present invention only includes the first connector 10, the second connector 20 and the fasting pin 30, and utilizes the friction resistance force between the locking ribs 215 of the second connector 20 and the inside of the pivotal sleeve 11 of the first connector 10 to make the display apparatus 41 positioned at any inclined angle relative to the host body 42. So the hinge of the present invention has simple structure and assembly, and further reduces the manufacture cost.

What is claimed is:

1. A hinge adapted to be connected between a display apparatus and a host body of a foldable electronic appliance for permitting the display apparatus to be swiveled relative to the host body, the hinge comprising:
a second connector having a hollow pivotal device and a second fastening member adapted to be fastened to the host body of the electronic appliance, a peripheral outside of the pivotal device protruding outward to form a locking rib;
a first connector having a pivotal sleeve and a first fastening member adapted to be fastened to the display apparatus of the electronic appliance, the pivotal sleeve being pivotally sleeved to the pivotal device to make the first connector rotatable relative to the second connector and further make the display apparatus swivelable relative to the host body, the locking rib of the pivotal device being able to slide along and abut against a peripheral inside of the pivotal sleeve to produce friction resistance force therebetween for positioning the display apparatus at any inclined angle relative to the host body; and
a fastening pin disposed in the pivotal device of the second connector and spaced from a peripheral inside of the pivotal device so that can make the pivotal device pressed inward to produce an outward elasticity to strengthen the friction resistance force between the locking rib and the peripheral inside of the pivotal sleeve.

2. The hinge as claimed in claim 1, wherein the fastening pin includes an inserting bar and a handle portion connected with one end of the inserting bar, the diameter of the inserting bar is gradually reduced from the one end of the inserting bar to the other end of the inserting bar, the inserting bar is inserted in the pivotal device of the second connector.

3. The hinge as claimed in claim 2, wherein a peripheral outside of the one end of the inserting bar is provided with a male thread adjacent to the handle portion, a free end of the peripheral inside of the pivotal device is provided with a female thread screwed with the male thread by means of turning around the handle portion inwardly.

4. The hinge as claimed in claim 1, wherein the peripheral inside of the pivotal sleeve of the first connector defines a buckling groove for locking the locking rib of the second connector therein.

5. The hinge as claimed in claim 4, wherein the locking rib of the second connector has two oppositely protruded and parallel to the axis of the pivotal device, and the buckling groove has two parallel with and symmetrical about the axis of the pivotal sleeve.

6. The hinge as claimed in claim 1, wherein the pivotal device of the second connector includes a prop pillar connected with the second fastening member and a cylindrical hollow pintle extending from a middle of an end surface of the prop pillar, a peripheral outside of a free end of the pintle protrudes outward to form a restraining portion, the pivotal sleeve of the first connector is pivotally sleeved to the pintle through the restraining portion and is restrained between the prop pillar and the restraining portion, the locking rib is formed at the peripheral outside of the pintle and between the prop pillar and the restraining portion.

7. The hinge as claimed in claim 6, wherein restraining portion is of hollow cone shape having one end with the shortest diameter adjacent to a free end mouth of the pintle.

8. The hinge as claimed in claim 1, wherein the pivotal device of the second connector includes a prop pillar connected with the second fastening member and a cylindrical hollow pintle extending from a middle of an end surface of the prop pillar, the pintle defines a plurality of slots which are parallel with and symmetrical about the axis of the pintle and penetrate through a free end of the pintle, each of the slots further radially penetrates through the pintle, and the pivotal sleeve of the first connector is pivotally sleeved to the pintle of the pivotal device.

9. The hinge as claimed in claim 8, wherein a peripheral outside of the free end of the pintle protrudes outward to form a restraining portion, the slots further penetrate through the restraining portion, the pivotal sleeve is restrained between the prop pillar and the restraining portion through the restraining portion.

10. The hinge as claimed in claim 8, wherein the locking rib is formed at the peripheral outside of the pintle and parallel to the slots.

11. The hinge as claimed in claim 1, wherein the first fastening member of the first connector includes a coupling flap and a connection plate connecting the pivotal sleeve and the coupling flap, the coupling flap is further connected with a peripheral outside of the pivotal sleeve along a generatrix of the pivotal sleeve for always showing an oblique angle between the coupling flap and a corresponding diameter which passes through the junction of the coupling flap and the pivotal sleeve, and further an oblique angle is formed between the connection direction of the connection plate and the plane of the coupling flap.

12. The hinge as claimed in claim 11, wherein the coupling flap defines a plurality of fastening holes each penetrating therethrough for fastening the coupling flap to the display apparatus.

13. The hinge as claimed in claim 1, wherein the second fastening member of the second connector includes a fastening dock and a connection board connecting the pivotal device and the fastening dock, the plane of the fastening dock is perpendicular to that of the connection board and parallel to the pivotal device, and further shows an oblique angle about the extension direction of the connection board, the pivotal device is connected at the same side of the connection board as the fastening dock.

14. The hinge as claimed in claim 13, wherein the fastening dock defines a plurality of fastening apertures each penetrating therethrough for fastening the fastening dock to the host body.
